(19) United States
(12) Patent Application Publication
(10) Pub. No.: US 2023/0067155 A1
(43) Pub. Date: Mar. 2, 2023

(54) DETECTING SPOOF COMMUNICATIONS USING NON-FUNGIBLE TOKENS ON A DISTRIBUTED LEDGER

(71) Applicant: Total Network Services Corp., Carlsbad, CA (US)

(72) Inventors: Kevin L. JACKSON, Manassas, VA (US); Thomas N. CARTER, Vista, CA (US)

(21) Appl. No.: 17/899,287

(22) Filed: Aug. 30, 2022

Related U.S. Application Data
(60) Provisional application No. 63/239,900, filed on Sep. 1, 2021.

(51) Int. Cl. H04M 3/436; H04M 3/42; H04L 9/32

(52) U.S. Cl. CPC H04M 3/436; H04M 3/42059; H04L 9/3213; H04M 2203/6027

(57) ABSTRACT

Methods, systems, and apparatus, including computer programs encoded on a computer storage medium, for detecting spoof communications are disclosed. In one aspect, a method includes the actions of receiving data identifying a first computing device and a phone number of the first computing device. The actions further include generating an NFT that includes metadata that includes the data identifying the first computing device and the phone number of the first computing device. The actions further include receiving data indicating that a second computing device with the phone number is placing a telephone call and data identifying the second computing device. The actions further include accessing the NFT. The actions further include comparing the data identifying the second computing device to the data identifying the first computing device included in the metadata of the NFT. The actions further include determining whether the phone number is likely being spoofed.

### CROSS-REFERENCE TO RELATED APPLICATION

This application claims the benefit of U.S. Application 63/239,900, filed Sep. 1, 2021, which is incorporated by reference.

### BACKGROUND

A distributed ledger is a consensus of replicated, shared, and synchronized digital data geographically spread across multiple sites, countries, or institutions. A blockchain is a type of distributed ledger and is a growing list of records, called blocks, that are securely linked together using cryptography. Each block contains a cryptographic hash of the previous block, a timestamp, and transaction data. The timestamp proves that the transaction data existed when the block was published to get into its hash. As blocks each contain information about the block previous to it, they form a chain, with each additional block reinforcing the ones before it. Blockchains may be resistant to modification of their data because once recorded, the data in any given block cannot be altered retroactively without altering all subsequent blocks.

A non-fungible token (NFT) is a security token consisting of digital data stored in a blockchain. The ownership of an NFT is recorded in the blockchain, and can be transferred by the owner, allowing NFTs to be sold and traded.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example system that is configured to detect spoof communications using NFTs.

FIG. 2 illustrates an example server that is configured to detect spoof communications using NFTs.

FIG. 3 is a flowchart of an example process to detect spoof communications using NFTs.

### DETAILED DESCRIPTION

This disclosure describes techniques to determine whether an incoming communication request is a spoof communication. In some cases, an ill-intentioned third party may initiate a real-time communication from a phone number that is known to the call recipient, despite the real-time communication having been initiated from a different telephone number. This practice, also known as caller ID spoofing, creates a misplaced assurance in call recipients that the identity of a third-party and/or origin of the real-time communication, is known to them.

In this disclosure, a caller identity controller may be configured to generate a permissible list of callers, which is based on having verified the Mobile Equipment Identifiers (MEIDs) associated with caller electronic devices. The caller identity controller may intercept a communication request initiated by a sending device and determine whether the initiating caller is registered on the permissible list of callers. If the initiating caller is determined to be a legitimate call (e.g., initiating caller identifier is included on the permissible list of callers), the caller identity controller may permit the communication request to continue by establishing the real-time communication with the recipient caller. Otherwise, if the caller identity controller determines that the initiating caller is not included on the permissible list of callers, the caller identity controller may analyze the communication request to infer a likelihood that the communication request is associated with a spoof communication.

The caller identity controller may verify the identity of the initiating caller using a Non-Fungible Token (NFT) that is associated with the electronic device of the initiating caller. An NFT comprises a cryptographic token, namely a unit of data that is not mutually interchangeable, and that can be stored on a distributed ledger, such as a blockchain. The caller identity controller may be configured to create a cryptographic token (e.g., NFT) that can be used to verify the authenticity of an electronic device. Accordingly, the caller identity controller may verify the identity of an initiating caller using the NFT of the electronic device that the initiating caller used to initiate a communication request.

The NFT associated with an electronic device may be based on a Mobile Equipment Identifier (MEID) of the electronic device. MEID is a globally unique 56-bit identification number that Is associated with an electronic device. Electronic devices do not share the same MEID. Typically, equipment identifiers, such as MEIDs, are permanently etched onto the physical structure of the electronic device, enabling consumers and vendors to identify and track the electronic device. Thus, the MEID can be used as proof of ownership of an electronic device, and by extension, proof of identity of its owner. Further, an NFT that is based on the MEID provides an added level of integrity to ensure that cloned or counterfeit electronic devices that purport to hold the same MEID as that of a legitimate caller, are not inadvertently identified as the legitimate caller.

The caller identity controller may also infer a likelihood that a communication request is associated with a spoof communication based on temporal indicators associated with the communication request. For example, if the communication request has been initiated from the geolocation known for generating spoofed communications, the caller identity controller may infer that the communication request is likely a spoofed communication. In this example, the caller identity controller may employ one or more trained machine learning algorithms to analyze historic communication requests to infer a likelihood that the communication request is a spoof communication. The caller identity controller may make use of one or more trained machine-learning algorithms such as supervised learning, unsupervised learning, semi-supervised learning, naive Bayes, Bayesian network, decision trees, neural networks, fuzzy logic models, and/or probabilistic classification models.

The caller identity controller may assign a communication request a spoof score that is intended to indicate the likelihood that the communication request is a spoof communication. The spoof score may be alpha-numeric (e.g., 0 to 10, or A to F), descriptive (e.g., low, medium, or high), based on color, (e.g., red, yellow, or green), or any other suitable rating scale. A high spoof-likelihood score (e.g., 7 to 10, high, or red) may indicate that a communication request is likely a spoofed communication. In contrast, a low similarity score (e.g., 0 to 3, low, green) may indicate that a communication request is unlikely a spoofed communication.

In response to determining that a communication request is likely a spoof communication, the caller identity controller may permit the communication request to continue and present a set of selectable options on a display of the recipient device. The selectable options may include a “thumbs up” icon, representing a legitimate communication, and a “thumbs down” icon, representing a spoof communication. If the recipient selects the “thumbs up” icon, the set of selectable options may disappear from the display of the recipient device, and the recipient may choose to accept the communication request using the typical call answer functionality of the recipient device. Otherwise, if the “thumbs down” icon is selected, the caller identity controller may perform acts to terminate the communication request, and in doing so, record an indication that the communication request (and the initiating caller) was a spoof communication (and spoof caller).

Rather than preselecting “thumbs up” or “thumbs down” prior to establishing the communication, the recipient may choose to affirmatively respond to the communication request without selecting a “thumbs up” or “thumbs down” option. In this scenario, the set of selectable options may remain on the display of the recipient device for a predetermined time interval. In this way, if the recipient was unsure of whether the communication request was a legitimate communication or a spoof communication, the recipient may affirmatively respond to the communication request and within the predetermined time interval, decide whether the initiated call is a legitimate communication or a spoof communication. At this point, the recipient may select an appropriate “thumbs up” option to continue the communication (e.g., legitimate communication) or a “thumbs down: option to terminate the communication (e.g., spoof communication).

Each time a recipient selects a “thumbs up” or “thumbs down” the caller identity controller may add a validation response credit to a recipient account. Once the validation response credits within the recipient account accumulate to a predetermined credit threshold, the caller identity controller may provide the recipient with an offer to convert the accumulated validation response credits to an alternate form of consideration. The consideration may include gift cards to a predetermined selection of merchant stores. Alternatively, or additionally, the consideration may take the form of cryptocurrency that is credited to a cryptocurrency wallet associated with the recipient. Since the value of cryptocurrency can change in a free marketplace, the caller identity controller may determine the market value of a particular cryptocurrency on the day and time of the offer to the recipient. The offer to the recipient can be assessed based on the assigned currency value of validation response credit relative to the market value of the particular cryptocurrency. For example, consider a recipient with 500 validation response credits. if each validation response credit is assigned a value of five U.S. cents, the currency value of the 500 validation response credits equates to $25. Accordingly, the caller identity controller may determine whether the real-time market value of a particular cryptocurrency equates to $25. If so, the caller identity controller may present the recipient with an offer to exchange the 500 validation response credits for the particular cryptocurrency that retains a real-time market value of $25.

Throughout this disclosure, a real-time communication is described as a voice communication or a video communication. However, variations and modifications can be made such that the caller identity controller may be configured to indicate whether text messages received at a recipient device are legitimate text messages or spoof text messages.

The electronic device may include any sort of electronic devices, such as a television unit, a multimedia streaming device, a cellular phone, a smartphone, a tablet computer, an electronic reader, a media player, a gaming device, a personal computer (PC), a laptop computer, etc. The electronic device may also include network devices that act as intermediaries with the Internet. It is noteworthy that the Internet is accessible via one or more network(s). In some examples, the operator device and the user device may include a subscriber identity module (SIM), such as an eSIM, to identify each device to a telecommunication service provider (also referred to herein, as “telecommunications network”).

The caller identity controller may operate on one or more distributed computing resource(s). The one or more distributed computing resource(s) may include one or more computing device(s) that operate in a cluster or other configuration to share resources, balance load, increase performance, provide fail-over support or redundancy, or for other purposes. The one or more computing device(s) may include one or more interfaces to enable communications with other networked devices via one or more network(s).

The one or more network(s) may include public networks such as the Internet, private networks such as an institutional and/or personal intranet, or some combination of a private and public network(s). The one or more network(s) can also include any type of wired and/or wireless network, including but not limited to local area network (LANs), wide area network(s) (WANs), satellite networks, cable networks, Wi-Fi networks, Wi-Max networks, mobile communications networks (e.g., 5G-NR, LTE, 3G, 2G), or any combination thereof.

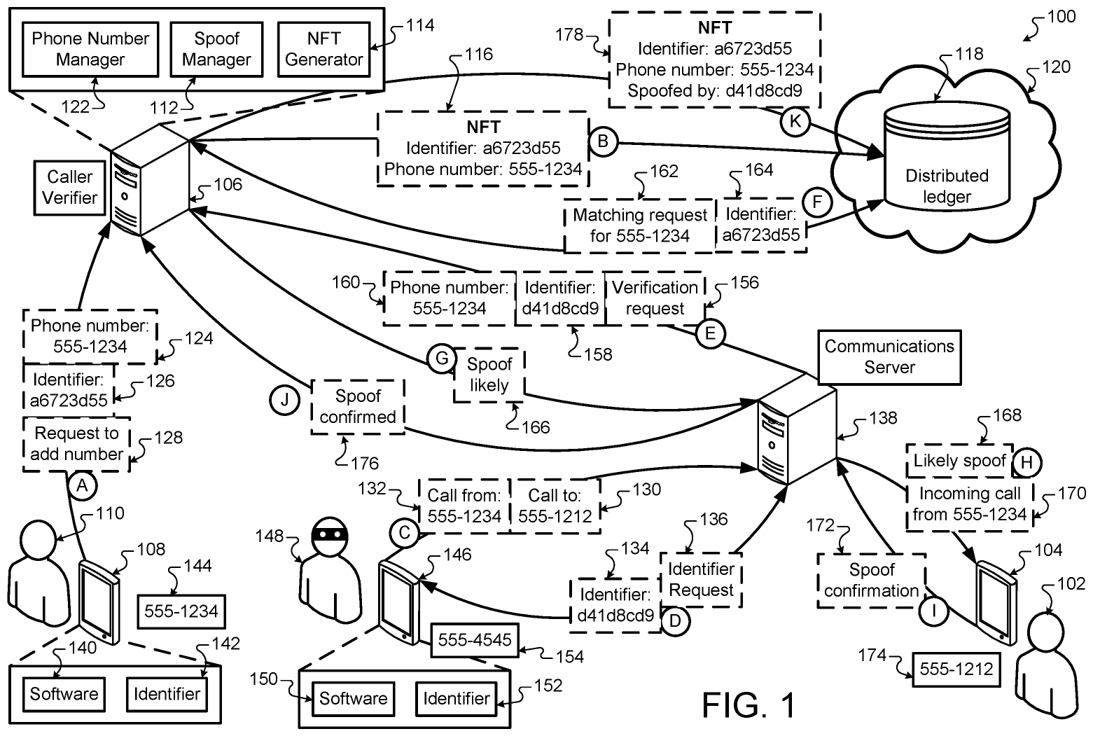

FIG. 1 illustrates an example system 100 that is configured to detect spoof communications using NFTs. Briefly, and as described in more detail below, the system 100 includes a caller verifier 106 that is configured to determine whether the phone number of a placed telephone call is spoofed. The caller verifier 106 may receive a phone number 144 and an identifier 142 of the phone 108 that corresponds to that phone number 144. The caller verifier 106 may store an NFT 116 that includes in the metadata the phone number 144 and the identifier 142 of the phone 108. When a communications server 138 receives data from a device indicating a placed telephone call, the communications server 138 may communicate with the caller verifier 106 to determine whether the phone number of the placed telephone call is likely spoofed. Based on that determination, the communications server 138 may provide a notification to the recipient of the telephone call indicating whether the phone number of the incoming telephone call is likely spoofed. FIG. 1 includes various stages A through K that may illustrate the performance of actions and/or the movement of data between various components of the system 100. The system 100 may perform these stages in any order.

In more detail and in stage A, the caller verifier 106 may receive a request 128 to provide a verification service for the phone number 144 of the phone 108. The request 128 may include an identifier packet 126 that includes the identifier 142 of the phone 108. The request 128 may also include a phone number packet 124 that includes the phone number 144 of the phone 108. The caller verifier 106 may be any type of computing device that is capable of communicating with other computing devices. For example, the caller verifier 106 may be a desktop computer, laptop computer, mobile phone, smart watch, tablet, and/or any other similar type of device. In some implementations, the caller verifier 106 may be a virtual computing device that is instantiated in the cloud. The phone 108 may be any type of device that is capable of placing and/or receiving telephone calls, voice calls, video calls, and/or any other similar type of real time communications. The phone 108 may also be any type of device that is capable of receiving and/or transmitting non-real time communications, such as text messaging, voice messaging, video messaging, and/or any other similar type of communications. For example, the phone 108 may be desktop computer, laptop computer, mobile phone, smart watch, tablet, and/or any other similar type of device.

The phone 108 may transmit the request 128 in response to an input from the user 110. In some implementations, the phone 108 may be configured to automatically transmit the request 124. For example, the phone 108 may automatically transmit the request 124 in response to loading a security application that the user 110 loaded onto the phone 108. As another example, the phone 108 may automatically transmit the request 124 in response to running security software that may be loaded by a network service provider that operates the network on which the phone 108 communicates. In some implementations, the phone 108 may automatically transmit the request 124 in response to connecting to a specific network.

The phone 108 may include the identifier 142 and software 140. The software 140 may be any type of software that is stored and/or accessible by the phone 108. For example, the software 140 may be the operating system of the phone 108, the contents of the non-volatile storage on the phone 108, and/or any other similar software. The identifier 142 may be any unique identifier of the phone 108. The identifier 142 may be a serial number that may be combined with a model. The identifier 142 may be an MEID, an international mobile equipment identifier, a phone number, and/or any other unique identifier. In some implementations, the identifier 142 may be immutable. In the example of FIG. 1, the identifier 142 is 0xa6723d55.

The caller verifier 106 may include a phone number manager 122. The phone number manager 122 may be implemented by one or more physical or virtual processors executing instructions stored in and/or accessible by the caller verifier 106. The phone number manager 122 may be configured to receive the request 128 and begin the process of recording data related to the phone 108 on the distributed ledger 118. The process may include coordinating with the NFT generator 114. The NFT generator 114 may be implemented by one or more physical or virtual processors executing instructions stored in and/or accessible by the caller verifier 106

The phone number manager 122 may be configured to analyze the identifier 142 in the identifier packet 126 and determine whether the identifier 142 may be the same as previous identifiers. The previous identifiers may be stored in the distributed ledger 118. The identifier 142 and other identifiers may be selected such that no two identifiers are identical. Even in this case, the phone number manager 122 may confirm that the identifier 142 is not the same as any identifiers stored in the distributed ledger 118. If the phone number manager 122 does determine that the identifier 142 matches a previous identifier, then the phone number manager 122 may add a prefix and/or suffix to the identifier 142. The prefix and/or suffix may be a random collection of bytes, the model of the phone 108, and/or any similar data that is sufficient to make the identifier 142 unique.

In some implementations, the phone number manager 122 may receive the phone number packet 124 and the identifier packet 126 and not perform any checks to confirm whether the phone number 144 and/or the identifier 142 are unique. In this case, the caller verifier 106 may receive, in the phone number packet 124, a phone number that has been stored in the distributed ledger 118. This may be because the phone number 144 switched to a new user, the user switched devices, and/or any other similar reason. The identifier 142 may be a repeated identifier for similar reasons such as the user switching devices. In this case, the distributed ledger 118 may include out of date information.

The phone number manager 122 may provide instructions to the NFT generator 114. The instructions may include for the NFT generator 114 to generate an NFT 116 that includes the phone number 144 and the identifier 142 in the metadata of the NFT 116. In some implementations, the phone number manager 122 may provide instructions to the NFT generator 114 to include additional data in the metadata of the NFT 116. For example, the NFT generator 114 may receive an instruction to generate a hash of the phone 108 and store the hash in the metadata of the NFT 116. The caller verifier 106 may include a hash generator. The NFT generator 114 may provide the hash generator the instructions to generate the hash of the phone 108. The hash generator may generate a hash of the phone 108. In some implementations, the hash generator may generate a hash of the software 140 and/or other data stored on or accessible by the phone 108.

In some implementations, the request 128 may include additional data for the phone number manager 122 to determine the request 128 is authorized. For example, the request 128 may include a digital signature of the user 110. The phone number manager 122 may be configured to instruct the NFT generator to include the digital signature of the user 110 in the metadata of the NFT 116. Additionally, or alternatively, the phone number manager 122 may compare the digital signature of the user 110 to trusted digital signatures that may be stored on the caller verifier 106 and/or accessible by the caller verifier 106. If the phone number manager 122 determines that the digital signature of the user 110 matches a trusted digital signature, then the phone number manager 122 may instruct the NFT generator 114 to generate the NFT 116. The instructions may indicate to include or exclude the digital signature of the user 110. In some implementations, the phone number manager 122 determines that the digital signature of the user 110 does not match a trusted digital signature. In this case, the phone number manager 122 may instruct the NFT generator 114 to generate the NFT 116. The instructions may indicate to include the digital signature of the user 110 and data indicating that the digital signature is not from a trusted user. In some implementations, the phone number manager 122 may provide a notification to the user 110 and/or the phone 108 indicating that the request 128 is invalid because the digital signature of the user 110 does not match a trusted digital signature. In this case, the phone number manager 122 may move forward with adding the NFT 116 to the distributed ledger or indicate to the user 110 and/or the phone 108 that a digital signature of a trusted user is required to move forward with adding the NFT 116.

In the example of FIG. 1 and in stage B, the phone number manager 122 provides the NFT generator 114 instructions to generate an NFT 116. The instructions may indicate for the metadata of the NFT 116 to include the identifier 142 and the phone number 144. In some implementations, the instructions may indicate for the metadata of the NFT 116 to include the hash of the phone 108, the digital signature of the user 110, data indicating whether the digital signature is from a trusted user, and/or any other similar data. The instructions may indicate for the metadata of the NFT 116 to include additional data related to the phone 108. The data related to the phone 108 may include the location of the phone 108, the owner of the phone 108, the model of the phone 108, authorized users of the phone 108, a value of the phone 108, a purchase price of the phone 108, data identifying previous modifications of the phone 108, data identifying users who previously modified the phone 108, and/or any other similar data related to the phone 108.

In some implementations, the phone number manager 122 may determine that the distributed ledger 118 already includes another NFT that includes metadata that includes the identifier 142 and/or the phone number 144. In this case, the phone number manager 122 may determine the location in the distributed ledger 118 of the other NFT, a hash of the other NFT, the metadata of the other NFT, and/or any other data related to the other NFT. The phone number manager 122 may instruct the NFT generator 114 to include data related to the other NFT in the metadata of the NFT 116.

In the example of FIG. 1 and in stage C, the communications server 138 may receive a telephone call from the phone 146. The communications server 138 may be any type of computing device that is capable of communicating with other computing devices. For example, the communications server 138 may be a desktop computer, laptop computer, mobile phone, smart watch, tablet, and/or any other similar type of device. In some implementations, the communications server 138 may be a virtual computing device that is instantiated in the cloud. In some implementations, the communications server 138 may be or represent a wireless communications network that includes multiple devices that may include various base stations and communications equipment.

The communications server 138 may receive a calling telephone number packet 132 and a callee telephone number packet 130 after the user 148 places the telephone call using the phone 146. The phone 146 may be similar to the phone 108. The phone 146 may include software 150 and an identifier 152. The phone 146 may also have a corresponding phone number 154. The software 150 may be similar to the software 140 with the addition of software to allow the phone 146 to spoof another phone number. The user 148 may provide a different phone number and/or the phone 146 may generate the phone number for the phone 146 to present to the communications server 138 in the caller telephone number packet 132. In other words, the phone 146 spoofs the telephone number in the caller telephone number packet 132 because it includes a false telephone number instead of the actual telephone number 154.

The communications server 138 may be configured to verify that the telephone number in the caller telephone number packet 132 is not a spoofed telephone number. The communications server 138 may perform this verification automatically for each telephone call, in response to a request from a called device 104, in response to a request from the callee 102, in response to receiving data indicating that the phone number 144 and corresponding NFT 116 are stored in the distributed ledger 116, and/or any other similar reason.

In the example of FIG. 1 and in stage D, the communications server 138 may initiate the verification process by requesting an identifier 152 of the phone 146. The communications server 138 may transmit an identifier request 136 to the phone 146. The identifier request 136 may include instructions for the phone 146 to provide the identifier 152. The phone 146 may receive the identifier request 136 and output the identifier packet 134 that includes the identifier 152. The identifier 152 may be similar to the identifier 142 of the phone 108. For example, the identifier 152 may be Oxd41d8cd9. In some implementations, the phone 146 may provide the identifier 152 to the communications server 138 in stage C when the phone 146 provides the caller telephone number packet 132 and the callee telephone number packet 130.

In some implementations, the phone 146 may not respond to the identifier request 136 and/or may provide an invalid identifier. An invalid identifier may be one where a checksum bit indicates an invalid identifier or any other similar verification or integrity scheme. In this case, the communications server 138 may determine that the telephone number of the caller telephone number packet 132 is likely spoofed.

The communications server 138 may receive the caller telephone number packet 132, the callee telephone number packet 130, and the identifier packet 134. The communications server 138 may be configured to determine whether the telephone number of the caller telephone number packet 132 is likely spoofed. The communications server 138 may communicate with the caller verifier 106 to assist with making this determination.

The communications server 138 may transmit a verification request 156 to the caller verifier 106. The verification request 156 may indicate for the caller verifier 106 to determine whether the telephone number included in the telephone number packet 160 is spoofed. The communication server 138 may transmit the identifier packet 158 along with the verification request 156. The identifier packet 158 may include the identifier 152. The telephone number packet 160 may include the phone number from the callee telephone number packet 130.

In the example of FIG. 1 and in stage E, the communications server 138 may transmit, to the caller verifier 106, the verification request 156 with the identifier packet 158 and the telephone number packet 160. The identifier packet 158 may include the identifier 152, Oxd41d8cd9. The telephone number packet 160 may include the phone number from the callee telephone number packet 130, which is 555-1234. In some implementations, the communications server 138 may transmit additional data related to the phone 146. The data related to the phone 146 may include the location of the phone 146, the owner of the phone 146, the model of the phone 146, authorized users of the phone 146, a value of the phone 146, a purchase price of the phone 146, data identifying previous modifications of the phone 146, data identifying users who previously modified the phone 146, a hash of the phone 146, and/or any other similar data related to the phone 146. Some of this data may not be possible for the communications server 138 to determine. If in some cases, the communications server 138 is able to determine and/or access any of this additional data, then the communications server 138 may provide that additional data related to the phone 146 to the caller verifier 106.

The caller verifier 106 may receive the verification request 156 with the identifier packet 158 and the telephone number packet 160. The caller verifier 106 may include a spoof manager 112. The spoof manager 112 may be implemented by one or more physical or virtual processors executing instructions stored in and/or accessible by the caller verifier 106. The spoof manager 112 may be configured to determine whether the callee phone number of a placed telephone call is spoofed. The spoof manager 112 may access the distributed ledger 118 to determine whether the distributed ledger 118 includes an NFT that includes metadata that includes the phone number of the telephone number packet 160 and the identifier of the identifier packet 158. In that case, the spoof manager 112 may determine that the telephone number is likely not spoofed.

The spoof manager 112 may access the distributed ledger 118 to determine whether the distributed ledger 118 does not includes an NFT that includes metadata that includes the phone number of the telephone number packet 160 and the identifier of the identifier packet 158. In this case the spoof manager 112 may determine that the telephone number is likely spoofed. Determining that the distributed ledger 118 does not includes an NFT that includes metadata that includes the phone number of the telephone number packet 160 and the identifier of the identifier packet 158 may take various forms. The distributed ledger 118 may include an NFT that includes the phone number of the telephone number packet 160 but not an identifier that matches the identifier of the identifier packet 158. The distributed ledger 118 may include an NFT that does not include the phone number of the telephone number packet 160 but does include an identifier that matches the identifier of the identifier packet 158. The distributed ledger 118 may not include any NFTs that include either the phone number of the telephone number packet 160 or the identifier of the identifier packet 158.

In the example of FIG. 1 and in stage F, the spoof manager 112 may generate a matching request 162 for the telephone number of the telephone number packet 160. The matching request 162 may include the telephone number of the telephone number packet 160 and instructions to return an identifier included in the NFT that includes the telephone number of the telephone number packet 160 in the metadata. The instructions may further include to return data indicating not corresponding phone number if the distributed ledger 118 does not include an NFT that includes the telephone number of the telephone number packet 160 in the metadata. The distributed ledger 118 may receive the matching request 162 that includes the phone number 555-1234. The distributed ledger 118 may determine that NFT 116 includes that phone number and that NFT 116 includes the identifier 0xa6723d55 in the metadata of the NFT 116. The distributed ledger 118 may generate the identifier packet 164 that indicates the identifier 0xa6723d55 is located in an NFT that includes the matching telephone number. The distributed ledger 118 may transmit the identifier packet 164 to the caller verifier 106.

The spoof manager 112 may receive the identifier packet 164 and compare the identifier in the identifier packet 164 to the identifier of the identifier packet 158. If there is a match, then the spoof manager 112 may determine that the telephone number is likely not being spoofed. If there is not a match, then the spoof manager 112 may determine that the telephone number is likely being spoofed. In the example of FIG. 1 and in stage G, the spoof manager 112 may compare the identifier 0xa6723d55 of the identifier packet 164 to the identifier Oxd41d8cd9 of the identifier packet 158. The spoof manager 112 may determine that the two identifiers do not match. In this case, the spoof manager 112 may determine that the telephone number is likely spoofed. The spoof manager 112 may generate a spoof packet 166 that indicates whether the telephone number is likely spoofed. In this case, the spoof packet 166 indicates that the phone number is likely spoofed. The caller verifier 106 transmits the spoof packet 166 to the communications server 138.

The communications server 138 receives the spoof packet 166. Based on the spoof packet 166, the communications server 138 may determine whether to connect the telephone call to the called device 104. In some implementations, the communications server 138 may determine to block the telephone call if the spoof packet 166 indicates that the phone number is likely spoofed. In some implementations, the communications server 138 may determine to connect the telephone call and include a warning for the called device 104 if the spoof packet 166 indicates that the phone number is likely spoofed. In some implementations, the communications server 138 may determine to connect the telephone call if the spoof packet 166 indicates that the phone number is likely not spoofed. In some implementations, the communications server 138 may determine whether to connect the telephone call based on preferences received from the callee 102.

In the example of FIG. 1 and in stage H, the communications server 138 generates a telephone call notification 170 that indicates an incoming call to the called device 104. The telephone call notification 170 may include the telephone number of the calling telephone number packet 132. The communication server 138 may also generate a spoof indication packet 168. The spoof indication packet 168 may indicate whether the telephone number in the telephone call notification 170 is likely spoofed. In this case, the spoof indication packet 168 may indicate that the telephone number is likely spoofed.

The called device 104 may receive the telephone call notification 170 and the spoof indication packet 168. In some implementations, the communications server 138 may not transmit a spoof indication packet 168 that indicates that the telephone number is likely not spoofed. In the case of the spoof indication packet 168 indicating that the telephone number is likely spoofed, the called device 104 may output a notification indicating the incoming telephone call. The called device 104 may present the callee 102 with data indicating that the telephone number is likely spoofed. The callee 102 may decide whether to answer the telephone call.

In the example of FIG. 1 and in stage I, the callee 102 may answer the telephone call. In some implementations, the called device 104 may be configured to present selectable options to the callee 102. The selectable options may allow the callee 102 to provide input indicating whether the received telephone call was a spoofed call or not. In some implementations, the called device 104 may present the selectable options in response to receiving a spoof indication packet 168 that indicates a likely spoofed call. In some implementations, the called device 104 may present the selectable options in response to receiving a telephone call notification 170.

The callee 102 may determine that the user 148 spoofed the telephone number. The callee 102 may select the option to confirm the spoofing. The called device 104 may generate a spoof confirmation packet 172 that reflects the option selected by the callee 102. The spoof confirmation packet 172 may indicate that the telephone number was spoofed or not spoofed. In this case, the spoof confirmation packet 172 may indicate that the telephone number was spoofed. The called device 104 may transmit the spoof confirmation packet 172 to the communications server 138.

The communication server 138 receives the spoof communication packet 172 from the called device 104. The communication server 138 may generate a spoof summary packet 176 that includes the data confirming whether the telephone number was spoofed and additional data. The additional data may include the phone number 174 of the called device, the spoofed phone number, the identifier 152 of the phone 146, the date and time of the telephone call, data identifying the callee 102, a location of the called device 104, a location of the phone 146, a model of the phone 146, a model of the called device 104, an identifier of the called device 104, a hash of the called device 104, a hash of the phone 146, data identifying an owner of the spoofed phone number, data identifying a device associated with the spoofed phone number, and/or any other similar information. In the example of FIG. 1 and in stage J, the communication server 138 generates the spoof summary packet 176 that indicates the callee 102 confirmed that the phone number was spoofed.

The caller verifier 106 receives the spoof summary packet 176. The spoof manager 112 may instruct the NFT generator 114 to generate an additional NFT 178 that includes details related to the spoofed telephone call. The spoof manager 112 may instruct the NFT generator 114 to include various details related to the spoofed telephone call in the metadata of the NFT 178. Some of that data may be related to other NFTs that include data related to the phone 108, phone 146, and/or other similar data. The data related to the other NFTs may include the location of the other NFTs in the distributed ledger 118, the metadata of those NFTs, a hash of one or more of those NFTs, and/or any other similar information. The data related to the phone 108 and/or the phone 146 may include the location of the phone, the owner of the phone, the model of the phone, authorized users of the phone, a value of the phone, a purchase price of the phone, data identifying previous modifications of the phone, data identifying users who previously modified the phone, a hash of the phone, and/or any other similar data related to the phone. The details related to the spoofed telephone call may include may include the phone number 174 of the called device, the spoofed phone number, the identifier 152 of the phone 146, the date and time of the telephone call, data identifying the callee 102, a location of the called device 104, a location of the phone 146, a model of the phone 146, a model of the called device 104, an identifier of the called device 104, a hash of the called device 104, a hash of the phone 146, data identifying an owner of the spoofed phone number, data identifying a device associated with the spoofed phone number, the data included in the spoof packet 166, and/or any other similar information.

In the example of FIG. 1 and in stage K, the spoof manager 112 receives the spoof summary packet 176. The spoof summary packet 176 may include the identifier 152 of the phone 146. The spoof manager 112 may transmit a request to the NFT generator 114 to generate an NFT 178 that includes, in the metadata, the identifier 142 and phone number 144 of the phone 144 and the identifier 152 of the spoofing phone 146. The NFT generator 114 stores the NFT 178 in the distributed ledger 118.

In some implementations, the spoof summary packet 176 may indicate that the telephone call was not spoofed. In this case, the spoof manager 112 may determine to bypass instructing the NFT generator 114 to generate the NFT 178. In some implementations, the spoof manager 112 may determine to instruct the NFT generator 114 to generate the NFT 178 if the spoof manager 112 determined that the telephone call was likely spoofed and the spoof summary packet 176 indicated that the telephone call was not spoofed. The spoof manager 112 may determine to bypass instructing the NFT generator 114 to generate the NFT 178 if the spoof manager 112 determined that the telephone call was likely not spoofed and the spoof summary packet 176 indicated that the telephone call was not spoofed.

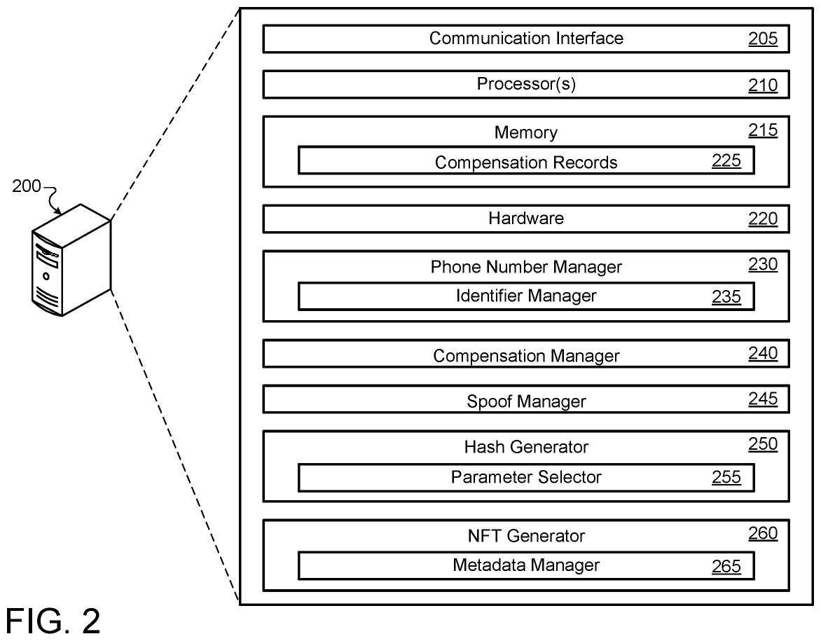

FIG. 2 illustrates an example server 200 that is configured to detect spoof communications using NFTs. The server 200 may be any type of computing device that is configured to communicate with other computing devices. The server 200 may communicate with other computing devices using a wide area network, a local area network, the internet, a wired connection, a wireless connection, and/or any other type of network or connection. The wireless connections may include Wi-Fi, short-range radio, infrared, and/or any other wireless connection. The server 200 may be similar to the asset manager 106 of FIG. 1. Some of the components of the server 200 may be implemented in a single computing device or distributed over multiple computing devices. Some of the components may be in the form of virtual machines or software containers that are hosted in a cloud in communication with disaggregated storage devices.

The server 200 may include a communication interface 205, one or more processors 210, memory 215, and hardware 220. The communication interface 205 may include communication components that enable the server 200 to transmit data and receive data from other devices and networks. In some implementations, the communication interface 205 may be configured to communicate over a wide area network, a local area network, the internet, a wired connection, a wireless connection, and/or any other type of network or connection. The wireless connections may include Wi-Fi, short-range radio, infrared, and/or any other wireless connection.

The hardware 220 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 215 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The one or more processors may implement a phone number manager 230. The phone number manager 230 may be similar to the phone number manager 122 of FIG. 1. The phone number manager 230 may be configured to receive and respond to various request from computing devices as well as generate and output requests to those and other computing devices. Some of the requests the phone number manager 230 may receive includes request to add a phone number and phone identifier to a distributed ledger. Other requests may include to determine whether a phone number and/or device identifier have been added to an NFT in a distributed ledger.

The phone number manager 230 may include an identifier manager 235. The identifier manager 235 may be configured to determine whether an identifier received in a request to add a phone number to the distributed ledger is unique. In some implementations, the identifier manager 235 may be configured to access the distributed ledger to determine which identifiers the phone number manager 230 has previously received requests to add to the distributed ledger and added the corresponding identifier and phone number pair to the distributed ledger. In some implementations, the identifier manager 235 may store, in the memory 215, the identifiers of phones that have been stored in the distributed ledger. The identifier manager 235 may compare a received identifier to the identifiers stored in the memory 215 and/or the identifiers in the distributed ledger. In some implementations, the identifier manager 235 may not perform any additional actions in the case of the identifier manager 235 determining that the received identifier matches a previously received identifier.

The one or more processors may implement a spoof manager 245. The spoof manager 245 may be similar to the spoof manager 112 of FIG. 1. The spoof manager 112 may be configured to determine whether placed telephone call is using a spoofed telephone number. The spoof manager 245 may be configured to access a distributed ledger to make this determination in conjunction with data related to the telephone call received from a communications server. The spoof manager 245 may receive a verification request from the communications server. The verification request may receive the phone number of a calling device and an identifier of the calling device. The spoof manager 245 may access the distributed ledger to determine whether the distributed ledger includes an NFT that includes, in the metadata of the NFT, the phone number of the calling device. If the spoof manager 245 determines that the identifier in the metadata of the NFT that included the phone number of the calling device does not match the identifier of the calling device, then the spoof manager 245 determines that the calling device likely spoofed the phone number. If the spoof manager 245 determines that the identifier in the metadata of the NFT that included the phone number of the calling device matches the identifier of the calling device, then the spoof manager 245 determines that the calling device likely did not spoof the phone number.

In some implementations, the spoof manager 245 may be configured to use additional data related to the telephone call and/or additional stored in the NFTs of the distributed ledger to determine whether the calling device is likely spoofing the phone number. An NFT that includes the phone number and a corresponding authorized identifier may include additional metadata. The additional metadata may include data related to the phone that corresponds to the authorized identifier. The data related to the phone may include authorized locations where the locations from which the phone can place telephone calls, an owner of the phone, a model of the phone, authorized users of the phone, a value of the phone, a purchase price of the phone, data identifying previous modifications to the phone, data identifying users who previously modified the phone, and/or any other similar data.

The NFT and other NFTs that includes the phone number may include data related to previous telephone calls originating from the phone number that were identified as likely spoofing the telephone number and/or confirmed to be spoofing the telephone number. The data related to the previous telephone calls may include data identifying an actual phone number of the calling device, a phone number of the called device, the identifier of the calling device, the date and time of the telephone call, data identifying the caller, data identifying the callee, a location of the called device, a location of the calling device, a model of the called device, a model of the calling device, an identifier of the called device, a hash of the called device, a hash of the calling device, data identifying an owner of the called device, data identifying the owner of the calling device, data indicating whether the telephone call was identified as a confirmed spoof by a callee and/or a likely spoof by the caller verifier, and/or any other similar information.

In some implementations, the distributed ledger may include NFTs related to telephone calls originating from the phone number that were identified as likely not spoofing the telephone number and/or confirmed to be not spoofing the telephone number. These NFTs may include any data described above with respect to the other NFTs that includes the phone number and/or that include metadata related to previous telephone calls originating from the phone number that were identified as likely spoofing the telephone number and/or confirmed to be spoofing the telephone number

The spoof identifier 245 may use the data stored in the NFTs that include data related to the calling telephone number to determine whether the telephone number is likely spoofed. In some implementations, the spoof identifier 245 may use various rules to determine whether the telephone number is likely spoofed. The rules may be stored in the memory 215. For example, a rule may indicate for the for the spoof identifier 245 to determine that the telephone number is likely spoofed if the identifier of the calling device does not match the identifier in the metadata of the NFT that includes the telephone number. Another rule may indicate for the spoof identifier 356 to determine that the telephone number is likely spoofed if the location of the calling device is not in a location that corresponds to previous locations of the device calling from that phone number.

In some implementations, the spoof identifier 245 may use models trained using machine learning to determine whether the telephone number is likely spoofed. The spoof identifier 245 may use machine learning and historical data to train the models. The spoof identifier 245 may store the trained models in the memory 215. The historical data may include data related to previous telephone calls and a label that indicates whether each of the calling telephone number was spoofed. The data related to previous telephone calls may include an owner of the calling and called device, a model of the called device and calling device, authorized user of the calling and called device, a value of the calling and called device, a purchase price of the calling and called device, data identifying previous modifications to the calling and called device, data identifying users who previously modified the calling and called device, locations from where the calling and called devices can place a telephone call to other devices that may include the called and calling devices, locations from where the called and calling devices can receive telephone calls from other devices that may include the called and calling devices, the phone number of the calling device and the called device, the identifier of the calling and called device, the date and time of the telephone call, data identifying the caller and callee, a location of the calling and called device, a hash of the calling and called device, data indicating whether the telephone call was identified as a likely spoof or not a likely spoof by the spoof manager 245 or another spoof manager, and/or any other similar information.

The resulting one or more models may be configured to receive data similar to the data used to train the model with the exception of whether the telephone number was confirmed to be spoofed. The resulting models may output data indicating whether the telephone number is likely spoofed. In some implementations, the models may be configured to output a spoof score that indicates a likelihood that the telephone number is spoofed. The range may be between zero and one. A spoof score of 0.1 may indicate a low likelihood that the phone number is spoofed. A spoof score of 0.9 may indicate a high likelihood that the phone number is spoofed. A spoof core of 0.5 may indicate an equal likelihood that the phone number is spoofed or not spoofed.

In some implementations, the spoof manager 112 may provide the spoof score to the communications server in response to the verification request. The communications server may instruct the called device to display different interfaces depending on the spoof score. For example, if the spoof score is below 0.2, then the communications server may instruct the called device to not display an indication that the phone number may be spoofed. If the spoof score is between 0.2 and 0.6, then the communications server may instruct the called device to display an indication that the phone number may be spoofed. If the spoof score is above 0.6, then the communications server may block the telephone call and instruct the called device to display a notification of the blocked call along with the calling telephone number. In any of these situations, the communications server may instruction the called device to display selectable options for the user to input data indicating whether the phone number is spoofed.

The spoof manager 112 may receive the data from the user selection of the selectable options. The spoof manager 112 may update the historical data used to train the models so that the historical data includes the data provided to the model and the data confirming whether the phone number was spoofed. The spoof manager 112 may retrain the models using the updated historical data.

The one or more processors 210 may implement a hash generator 250. The hash generator 250 may generate the hash of a phone or other device. The hash generator 250 may include a parameter selector 255. The parameter selector 255 may be configured to identify the data for the hash generator 250 to apply to the hash function. The parameter selector 255 may be configured to identify the type of device. Based on the type of device, the parameter selector 255 may select a parameter, or argument, for the hash function. In some implementations, the parameter selector 255 may be configured to select the same argument for each device of the same type. For example, the parameter selector 255 may identify the device as a mobile phone. For mobile phones, the parameter selector 255 may select the argument of the software stored in the non-volatile memory.

The NFT generator 260 may receive instructions to generate an NFT of the phone number from the spoof manager 245. The one or more processors 210 may implement the NFT generator 260. The NFT generator 260 may be similar to the NFT generator 114 of FIG. 1. The NFT generator 260 may generate the NFT for the phone number using a similar technique as described above with respect to FIG. 1. The NFT generator 260 may include a metadata manager 265. The metadata manager 265 may be configured select the metadata to include in the NFT. The metadata manager 265 may select the metadata based on the type of device that corresponds to the phone number and/or the data available. For example, the metadata manager 265 may determine that the device that corresponds to the phone number is a mobile phone. In this case, the metadata manager 265 may determine to select the hash of the mobile phone, the identifier of the mobile phone, the model of the mobile phone, and/or any other similar information. Other data that the metadata manager 265 may include in the metadata are data identifying the owner of device that corresponds to the phone number, a model of the device, authorized user of the device, a value of the device, a purchase price of the device, data identifying previous modifications to the device, data identifying users who previously modified the device, locations from where the devices can place a telephone call to other devices, locations from where the devices can receive telephone calls, the phone number of the device, the identifier of the device, a current location of the device, a hash of the device, and/or any other similar information.

In instances where the NFT generator 260 receives instructions to generate an additional NFT for a phone number as may be the case if the server 200 receives data confirming whether the phone number was or was not spoofed, then the metadata manager 265 may select additional metadata for another NFT. The metadata for the other NFT may include data similar to the previous NFT in addition to data identifying an owner of the calling and called device, a model of the called device and calling device, authorized users of the calling and called device, a value of the calling and called device, a purchase price of the calling and called device, data identifying previous modifications to the calling and called device, data identifying users who previously modified the calling and called device, locations from where the calling and called devices can place a telephone call to other devices that may include the called and calling devices, locations from where the called and calling devices can receive telephone calls from other devices that may include the called and calling devices, the phone number of the calling device and the called device, the identifier of the calling and called device, the date and time of the telephone call, data identifying the caller and callee, a location of the calling and called device, a hash of the calling and called device, data indicating whether the telephone call was identified as a likely spoofed or not a likely spoofed by the spoof manager 245, and/or any other similar information. In some implementations, the data related to the calling device may already be in another NFT if the phone number was no spoofed. In some implementations, the metadata manager 265 may also include data identifying the other NFT that includes the phone number. The data identifying the other NFT may include the location on the distributed ledger of the other NFT, the hash of the other NFT, and/or any other similar information.

The one or more processors 210 may implement a compensation manager 240. The compensation manager 240 may track whether callees respond to the requests for data confirming whether an incoming telephone call was from a spoofed phone number. The compensation manager 240 may award points to the callee if the callee responds to a spoof confirmation request. The compensation manager 240 may store the points in the compensation records 225 of memory 215. The compensation manager 240 may generate instructions for the called device to display the spoof confirmation request along with an indication of the points awarded for responding.

In some implementations, the compensation manager 240 may allow the users who have accumulated points to receive a prize. The prize may depend on the number of points that the user has accumulated with more valuable prizes being available to the users with more points.

In some implementations, the compensation manager 240 may be configured to award points based on the spoof score. The compensation manager 240 may award more points as the uncertainty reflected in the spoof score increases. In this way, the compensation manager 240 may offer the most points if the spoof score is 0.50 and the least points if the spoof score is 0.01 or 0.99 or whatever the minimum and maximum spoof scores may be. In other words, the award points may be indirectly proportional or indirectly related to an absolute value of the difference between the spoof score and 0.50. If the difference is low, then the award points are high. If the difference is high, then the award points are low. The compensation manager 240 may implement this system to encourage responses for situations where the spoof manager 245 has less certainty, which may provide data that increases that accuracy of any machine learning models used to identify spoofed telephone calls.

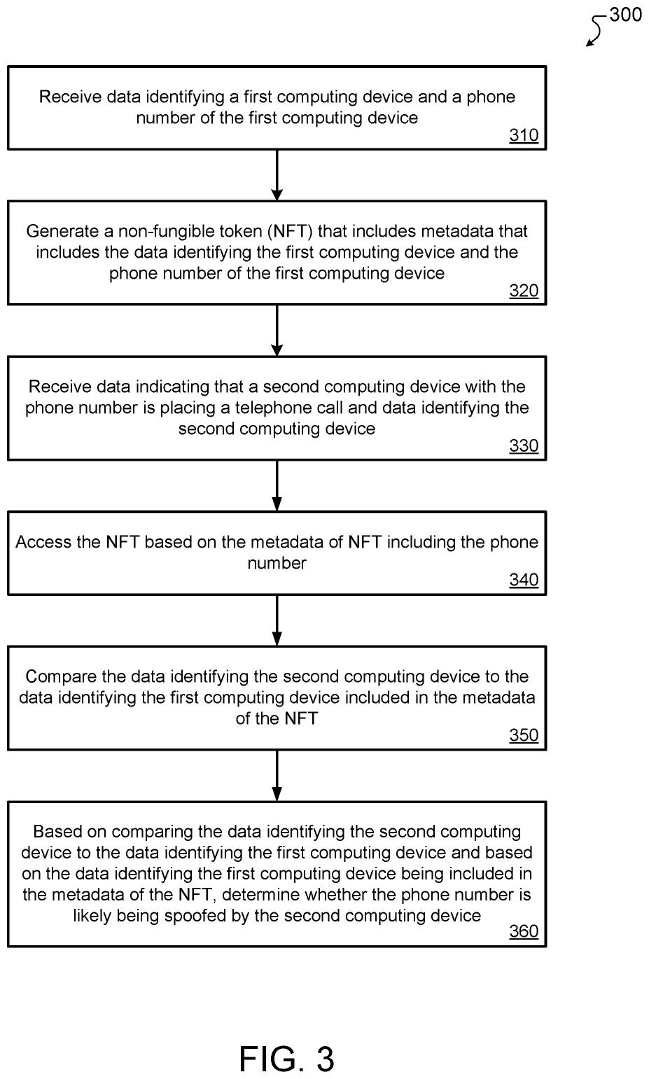

FIG. 3 is a flowchart of an example process 300 to detect spoof communications using NFTs. In general, the process 300 receives a phone number and an identifier of a phone. The process 300 generates an NFT that stores the phone number and the identifier and stores the NFT in a distributed ledger. In response to receiving data indicating that a device has placed a telephone call, the process 300 compares the phone number of the calling device to the phone numbers in the NFTs stored in the distributed ledger. If the process 300 identifies a matching phone number, then the process 300 compares the identifier of the calling device to the identifier in the NFT with the phone number. If there is a match, then the process 300 determines that the calling device likely did not spoof the phone number. If there is no match, then the process 300 determines that the calling device likely did spoof the phone number. The process 300 will be described as being performed by the caller verifier 106 of FIG. 1 and will include references to components of the FIG. 1. In some implementations, the process 300 may be performed by the server 200 of FIG. 2.

The caller verifier 106 receives data identifying a first computing device and a phone number of the first computing device (310). In some implementations, the data identifying the first computing device may be an MEID, an international mobile equipment identifier, and/or any other similar identifier of the first computing device that may be immutable. In some implementations, the caller verifier 106 may receive data indicating that another computing device received an additional telephone call from the telephone number and data indicating that a user of the other computing device confirmed that the telephone number was not spoofed. With this information, the caller verifier 106 may confirm that the telephone number belongs to the first computing device.

The caller verifier 106 generates a non-fungible token (NFT) that includes metadata that includes the data identifying the first computing device and the phone number of the first computing device (320). In some implementations, the caller verifier 106 may include additional metadata in the NFT. For example, the additional data may include a hash of the first computing device and/or any other similar data that may assist in identifying the first computing device.

The caller verifier 106 receives data indicating that a second computing device with the phone number is placing a telephone call and data identifying the second computing device (330). The caller verifier 106 may receive data identifying the second computing device. The data identifying the second computing device may be an MEID, an international mobile equipment identifier, and/or any other similar identifier. The caller verifier 106 may request the data identifying the second computing device from the second computing device or may receive the data identifying the second computing device from the second computing device as part of a request to verify the phone number. In some implementations, the caller verifier 106 may receive the data indicating that a second computing device from a telecommunications network.

The caller verifier 106 accesses the NFT based on the metadata of NFT including the phone number (340). The caller verifier 106 may request, from the distributed ledger, any NFTs that include, in the metadata, the phone number, the data identifying the second computing device, and/or the data identifying the first computing device. The caller verifier 106 determines the identifier that is stored in the NFT that includes the phone number.

The caller verifier 106 compares the data identifying the second computing device to the data identifying the first computing device included in the metadata of the NFT (350). The caller verifier 106 determines whether the data identifying the second computing device matches the data identifying the first computing device that was included in the NFT.

Based on comparing the data identifying the second computing device to the data identifying the first computing device and based on the data identifying the first computing device being included in the metadata of the NFT, the caller verifier 106 determines whether the phone number is likely being spoofed by the second computing device (360). If the caller verifier 106 determines that the data identifying the second computing device matches the data identifying the first computing device that was included in the NFT, then the caller verifier 106 determines that the phone number is likely not being spoofed and the first computing device is the same as the second computing device. If the caller verifier 106 determines that the data identifying the second computing device does not match the data identifying the first computing device that was included in the NFT, then the caller verifier 106 determines that the phone number is likely being spoofed and the first computing device is not the same as the second computing device. In some implementations, if the caller verifier 106 determines that the phone number is likely being spoofed, then the caller verifier 106 may output, to the telecommunications network, an instruction to block the telephone call.

In instances where the caller verifier 106 determines that the phone number is likely being spoofed, the caller verifier 106 may request verification from the called device. The caller verifier 106 may request that the telecommunications network confirm whether the phone number is likely spoofed. This may occur even if the caller verifier 106 determines that the phone number is likely not being spoofed. The caller verifier 106 may receive, from a user of the called device, data confirming whether the phone number is being spoofed. The caller verifier 106 may generate a new NFT that memorializes this telephone call. The NFT may include data related to the first and/or second computing devices, the telephone call, the called device, the users of the devices, and/or any other similar information.

In some implementations, the call verifier 106 may use an NFT that may memorialize a previous telephone call may to help determine whether a phone number is likely spoofed. In this case, the call verifier 106 may access NFTs that include any information related to the phone number, the called device, the calling device, the user, and/or any other similar information. The caller verifier 106 may use the data in the NFTs to determine whether the phone number is likely being spoofed.

In some implementations, the caller verifier 106 may provide an incentive to a user of the called device for the user to respond to the request to confirm whether a phone number is spoofed. The caller verifier 106 may reward points for responding to the requests and the user can redeem the points for various gifts or prizes.

Although a few implementations have been described in detail above, other modifications are possible. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method, comprising:
receiving, by a caller verification system, data identifying a first computing device and a phone number of the first computing device;
generating, by the caller verification system, a non-fungible token (NFT) that includes metadata that includes the data identifying the first computing device and the phone number of the first computing device;
receiving, by the caller verification system, data indicating that a second computing device with the phone number is placing a telephone call and data identifying the second computing device;
accessing, by the caller verification system, the NFT based on the metadata of NFT including the phone number;
comparing, by the caller verification system, the data identifying the second computing device to the data identifying the first computing device included in the metadata of the NFT; and
based on comparing the data identifying the second computing device to the data identifying the first computing device and based on the data identifying the first computing device being included in the metadata of the NFT, determining, by the caller verification system, whether the phone number is likely being spoofed by the second computing device.

2. The method of claim 1, comprising:
based on comparing the data identifying the second computing device to the data identifying the first computing device and based on the NFT being stored on the distributed ledger, determining, by the caller verification system, that the data identifying the second computing device matches the data identifying the first computing device,
wherein determining whether the phone number is likely being spoofed by the second computing device comprises:
based on the data identifying the second computing device matching the data identifying the first computing device, determining that the first computing device and the second computing device are a same computing device; and
based on determining that the first computing device and the second computing device are the same computing device, determining that the phone number is likely not being spoofed by the second computing device.

3. The method of claim 1, comprising:
based on comparing the data identifying the second computing device to the data identifying the first computing device and based on the NFT being stored on the distributed ledger, determining, by the caller verification system, that the data identifying the second computing device does not match the data identifying the first computing device,
wherein determining whether the phone number is likely being spoofed by the second computing device comprises:
based on the data identifying the second computing device not matching the data identifying the first computing device, determining that the first computing device and the second computing device are not a same computing device; and
based on determining that the first computing device and the second computing device are not the same computing device, determining that the phone number is likely being spoofed by the second computing device.

4. The method of claim 3, comprising:
based on determining that the phone number is likely being spoofed by the second computing device, providing, for output by the caller verification system, an instruction to block the telephone call.

5. The method of claim 1, wherein receiving the data identifying the first computing device comprises:
receiving, from the first computing device, (i) data indicating that a third computing device received an additional telephone call from the telephone number and (ii) data indicating that a user of the third computing device confirmed that the telephone number was not spoofed; and
determining, that the first computing device placed the additional telephone call from the telephone number.

6. The method of claim 1, comprising:
providing, for output to a third computing device that is a recipient of the telephone call, data indicating whether the phone number is likely being spoofed by the second computing device;
receiving, from a third computing device, data confirming whether the phone number is being spoofed by the second computing device; and
generating, by the caller verification system, an additional NFT that includes metadata that includes the data identifying the first computing device, the data identifying the second computing device, data identifying the NFT, the phone number, data indicating a date and time of the telephone call, and the data confirming whether the phone number is being spoofed by the second computing device.

7. The method of claim 6, comprising:
providing, by the caller verification system and to a user of the third computing device, an incentive to provide the data confirming whether the phone number is being spoofed by the second computing device

8. The method of claim 1, comprising:
generating, by the caller verification system, an additional NFT that includes metadata that includes the data identifying the first computing device, the data identifying the second computing device, data identifying the NFT, the phone number, data indicating a date and time of the telephone call, and data indicating whether the phone number was likely being spoofed by the second computing device.

9. The method of claim 8, comprising:
receiving, by the caller verification system, data indicating that a third computing device with the phone number is placing a telephone call and data identifying the third computing device;
accessing, by the caller verification system, the NFT and the additional NFT based on the metadata of NFT and the metadata of the additional NFT including the phone number;
comparing, by the caller verification system, the data identifying the third computing device to the data identifying the first computing device included in the metadata of the NFT; and
based on the metadata of the NFT, the metadata of the additional NFT, and the data identifying the third computing device, determining, by the caller verification system, whether the phone number is likely being spoofed by the third computing device.

10. A system, comprising:
one or more processors; and
memory including a plurality of computer-executable components that are executable by the one or more processors to perform a plurality of actions, the plurality of actions comprising:
receiving, by a caller verification system, data identifying a first computing device and a phone number of the first computing device;
generating, by the caller verification system, a non-fungible token (NFT) that includes metadata that includes the data identifying the first computing device and the phone number of the first computing device;
receiving, by the caller verification system, data indicating that a second computing device with the phone number is placing a telephone call and data identifying the second computing device;
accessing, by the caller verification system, the NFT based on the metadata of NFT including the phone number;
comparing, by the caller verification system, the data identifying the second computing device to the data identifying the first computing device included in the metadata of the NFT; and
based on comparing the data identifying the second computing device to the data identifying the first computing device and based on the data identifying the first computing device being included in the metadata of the NFT, determining, by the caller verification system, whether the phone number is likely being spoofed by the second computing device.

11. The system of claim 10, wherein the actions comprise:
based on comparing the data identifying the second computing device to the data identifying the first computing device and based on the NFT being stored on the distributed ledger, determining, by the caller verification system, that the data identifying the second computing device matches the data identifying the first computing device,
wherein determining whether the phone number is likely being spoofed by the second computing device comprises:
based on the data identifying the second computing device matching the data identifying the first computing device, determining that the first computing device and the second computing device are a same computing device; and
based on determining that the first computing device and the second computing device are the same computing device, determining that the phone number is likely not being spoofed by the second computing device.

12. The system of claim 10, wherein the actions comprise:
based on comparing the data identifying the second computing device to the data identifying the first computing device and based on the NFT being stored on the distributed ledger, determining, by the caller verification system, that the data identifying the second computing device does not match the data identifying the first computing device,
wherein determining whether the phone number is likely being spoofed by the second computing device comprises:
based on the data identifying the second computing device not matching the data identifying the first computing device, determining that the first computing device and the second computing device are not a same computing device; and
based on determining that the first computing device and the second computing device are not the same computing device, determining that the phone number is likely being spoofed by the second computing device.

13. The system of claim 12, wherein the actions comprise:
based on determining that the phone number is likely being spoofed by the second computing device, providing, for output by the caller verification system, an instruction to block the telephone call.

14. The system of claim 10, wherein receiving the data identifying the first computing device comprises:
receiving, from the first computing device, (i) data indicating that a third computing device received an additional telephone call from the telephone number and (ii) data indicating that a user of the third computing device confirmed that the telephone number was not spoofed; and
determining, that the first computing device placed the additional telephone call from the telephone number.

15. The system of claim 10, wherein the actions comprise:
providing, for output to a third computing device that is a recipient of the telephone call, data indicating whether the phone number is likely being spoofed by the second computing device;
receiving, from a third computing device, data confirming whether the phone number is being spoofed by the second computing device; and
generating, by the caller verification system, an additional NFT that includes metadata that includes the data identifying the first computing device, the data identifying the second computing device, data identifying the NFT, the phone number, data indicating a date and time of the telephone call, and the data confirming whether the phone number is being spoofed by the second computing device.

16. The system of claim 15, wherein the actions comprise:
providing, by the caller verification system and to a user of the third computing device, an incentive to provide the data confirming whether the phone number is being spoofed by the second computing device

17. The system of claim 10, wherein the actions comprise:
generating, by the caller verification system, an additional NFT that includes metadata that includes the data identifying the first computing device, the data identifying the second computing device, data identifying the NFT, the phone number, data indicating a date and time of the telephone call, and data indicating whether the phone number was likely being spoofed by the second computing device.

18. The system of claim 17, wherein the actions comprise:
receiving, by the caller verification system, data indicating that a third computing device with the phone number is placing a telephone call and data identifying the third computing device;
accessing, by the caller verification system, the NFT and the additional NFT based on the metadata of NFT and the metadata of the additional NFT including the phone number;
comparing, by the caller verification system, the data identifying the third computing device to the data identifying the first computing device included in the metadata of the NFT; and
based on the metadata of the NFT, the metadata of the additional NFT, and the data identifying the third computing device, determining, by the caller verification system, whether the phone number is likely being spoofed by the third computing device.

19. One or more non-transitory computer-readable media of a computing device storing computer-executable instructions that upon execution cause one or more computers to perform acts comprising:
receiving, by a caller verification system, data identifying a first computing device and a phone number of the first computing device;
generating, by the caller verification system, a non-fungible token (NFT) that includes metadata that includes the data identifying the first computing device and the phone number of the first computing device;
receiving, by the caller verification system, data indicating that a second computing device with the phone number is placing a telephone call and data identifying the second computing device;
accessing, by the caller verification system, the NFT based on the metadata of NFT including the phone number;
comparing, by the caller verification system, the data identifying the second computing device to the data identifying the first computing device included in the metadata of the NFT; and
based on comparing the data identifying the second computing device to the data identifying the first computing device and based on the data identifying the first computing device being included in the metadata of the NFT, determining, by the caller verification system, whether the phone number is likely being spoofed by the second computing device.

20. The media of claim 19, wherein the acts comprise:
based on comparing the data identifying the second computing device to the data identifying the first computing device and based on the NFT being stored on the distributed ledger, determining, by the caller verification system, that the data identifying the second computing device matches the data identifying the first computing device,
wherein determining whether the phone number is likely being spoofed by the second computing device comprises:
based on the data identifying the second computing device matching the data identifying the first computing device, determining that the first computing device and the second computing device are a same computing device; and
based on determining that the first computing device and the second computing device are the same computing device, determining that the phone number is likely not being spoofed by the second computing device.
